(19) United States
(12) Patent Application Publication
(10) Pub. No.: US 2025/0372004 A1
(43) Pub. Date: Dec. 4, 2025

(54) FLEXIBLE DISPLAY MODULE, METHOD FOR MANUFACTURING FLEXIBLE DISPLAY MODULE, AND DISPLAY DEVICE

(71) Applicant: Xiamen Tianma Display Technology Co., Ltd., Xiamen (CN)

(72) Inventors: Zhiwei WANG, Xiamen (CN); Yi ZHANG, Xiamen (CN); Jinjin YANG, Xiamen (CN)

(73) Assignee: Xiamen Tianma Display Technology Co., Ltd., Xiamen (CN)

(21) Appl. No.: 18/892,595

(22) Filed: Sep. 23, 2024

(30) Foreign Application Priority Data
May 31, 2024 (CN) 202410704343.X

(51) Int. Cl. G09F 9/30; G02B 5/30

(52) U.S. Cl. CPC G09F 9/301; G02B 5/30

(57) ABSTRACT

The present disclosure relates to a flexible display module, a method for manufacturing the flexible display module, and a display device. In the flexible display module, the polarizer is located on the light-emitting side of the first non-bending portion of the flexible display panel, and covers a display area and part of a non-display area; the bending protection layer and the polarizer are located on the same side of the flexible display panel, the bending protection layer covers the bending portion of the flexible display panel and is in contact with an edge of the polarizer; the adhesive layer is located on one side of the polarizer away from the flexible display panel and covers the polarizer and at least part of the bending protection layer; in the bending protection layer, the area in contact with the polarizer is the first area.

### CROSS-REFERENCE TO RELATED APPLICATIONS

This application claims priority to Chinese Patent Application No. 202410704343.X, titled “FLEXIBLE DISPLAY MODULE, METHOD FOR MANUFACTURING FLEXIBLE DISPLAY MODULE, AND DISPLAY DEVICE” and filed on May 31, 2024, which is hereby incorporated by reference in its entirety.

### TECHNICAL FIELD

The present disclosure relates to the field of display technology, and in particular to a flexible display module, a method for manufacturing the flexible display module, and a display device.

### BACKGROUND

With the rapid advancement of science and technology, flexible display technology has become an important force in promoting the innovation of electronic device forms. It not only expands the physical boundaries of traditional display screens, but also provides unlimited possibilities for the design of emerging products such as smart wearable devices, foldable screen mobile phones, and rollable TVs. Flexible display modules, with their unique bendability, can achieve static bending or dynamic deformation without compromising display performance, greatly improving user experience and product portability.

However, in the pursuit of ultimate visual effects and design aesthetics, how to further reduce the border width of flexible display modules, especially to achieve a narrower border design, is still a technical problem that needs to be solved urgently.

### SUMMARY

In order to solve the above-mentioned technical problems or at least partially solve the above-mentioned technical problems, the present disclosure provides a flexible display module, a method for manufacturing the flexible display module, and a display device.

In a first aspect, the present disclosure provides a flexible display module, comprising: a flexible display panel, a polarizer, a bending protection layer and an adhesive layer;
where the flexible display panel comprises a first non-bending portion, a second non-bending portion and a bending portion located between the first non-bending portion and the second non-bending portion; the first non-bending portion comprises a display area and a non-display area surrounding the display area;
the polarizer is located on a light-emitting side of the first non-bending portion, and covers the display area and part of the non-display area;
the bending protection layer and the polarizer are located on a same side of the flexible display panel, the bending protection layer covers the bending portion and is in contact with an edge of the polarizer;
the adhesive layer is located on one side of the polarizer away from the flexible display panel, and covers the polarizer and at least part of the bending protection layer;
in the bending protection layer, an area in contact with the polarizer is a first area; in the first area, a difference between a maximum thickness of the bending protection layer and a thickness of the polarizer is d, where 0≤d≤m, and a value of m is proportional to a thickness of the adhesive layer.

In a second aspect, the present disclosure further provides a flexible display module, comprising: a flexible display panel, a polarizer, a bending protection layer and an adhesive layer;
where the flexible display panel comprises a first non-bending portion, a second non-bending portion and a bending portion located between the first non-bending portion and the second non-bending portion; the first non-bending portion comprises a display area and a non-display area surrounding the display area;
the polarizer is located on a light-emitting side of the first non-bending portion, and covers the display area and part of the non-display area;
the bending protection layer and the polarizer are located on a same side of the flexible display panel, the bending protection layer covers the bending portion and is in contact with an edge of the polarizer;
the adhesive layer is located on one side of the polarizer away from the flexible display panel, and covers the polarizer and at least part of the bending protection layer;
in the bending protection layer, an area in contact with the polarizer is a first area; in the first area, a surface of the bending protection layer away from the flexible display panel is a plane or a cambered surface.

In a third aspect, the present disclosure further provides a method for manufacturing a flexible display module, the method is used to manufacture the flexible display module as described above, the method comprising:
providing the flexible display panel that comprises the first non-bending portion, the second non-bending portion and the bending portion located between the first non-bending portion and the second non-bending portion, where the first non-bending portion comprises the display area and the non-display area surrounding the display area;
attaching the polarizer to the light-emitting side of the first non-bending portion of the flexible display panel, where the polarizer covers the display area and part of the non-display area;
manufacturing the bending protection layer on the bending portion of the flexible display panel, where the bending protection layer and the polarizer are located on the same side of the flexible display panel and are in contact with the edge of the polarizer;
cutting the bending protection layer in the first area so that in the first area, the difference between the maximum thickness of the bending protection layer and the thickness of the polarizer is d, where 0≤d≤m, and the value of m is proportional to the thickness of the adhesive layer, the first area is the area in the bending protection layer that is in contact with the polarizer; and
manufacturing the adhesive layer on one side of the polarizer away from the flexible display panel, where the adhesive layer covers the polarizer and at least part of the bending protection layer.

In a fourth aspect, the present disclosure also provides a display device, including the flexible display module as described above.

The technical solution provided by the embodiments of the present disclosure has the following advantages over the prior art.

The technical solution provided by the embodiments of the present disclosure is set in the bending protection layer, and the area in contact with the polarizer is the first area; in the first area, the difference between the maximum thickness of the bending protection layer and the thickness of the polarizer is d, 0≤d≤m, and the value of m is proportional to the thickness of the adhesive layer, so that a height difference between a surface of the polarizer away from the flexible display panel and a surface of the bending protection layer away from the flexible display panel is within a maximum step difference filling capacity of the adhesive layer. In this way, there are no bubbles in the adhesive layer close to the contact position between the polarizer and the bending protection layer, or although there are bubbles, the size of the bubbles is extremely small. In this way, the overlap amount (that is, the size of the overlapping area between the light shielding layer and the polarizer in a direction perpendicular to the light-emitting surface of the flexible display panel) of the light shielding layer and the polarizer can be reduced later, thereby reducing the border of the display module.

### BRIEF DESCRIPTION OF THE DRAWINGS

The drawings herein are incorporated into the specification and constitute a part of the specification, showing embodiments consistent with the present disclosure, and are used together with the specification to explain the principles of the present disclosure.

In order to more clearly illustrate the technical solutions in the embodiments of the present disclosure or the prior art, the drawings required for use in the embodiments or the prior art description will be briefly introduced below. Apparently, for those skilled in this field, other drawings can also be obtained based on these drawings without creative labor.

FIG. 1 is a schematic structural diagram of an existing flexible display module;

FIG. 2 is a schematic structural diagram of a flexible display module in a manufacturing process of the existing flexible display module;

FIG. 3 is another schematic structural diagram of the flexible display module in the manufacturing process of the existing flexible display module;

FIG. 4 is a schematic structural diagram of the flexible display module according to an embodiment of the present disclosure;

FIG. 5 is a schematic structural diagram of the flexible display module in a manufacturing process of the flexible display module according to an embodiment of the present disclosure;

FIG. 6 is another schematic structural diagram of the flexible display module in the manufacturing process of the flexible display module according to an embodiment of the present disclosure;

FIG. 7 is another schematic structural diagram of the flexible display module in the manufacturing process of the flexible display module according to an embodiment of the present disclosure;

FIG. 8 is a schematic structural diagram of another flexible display module according to an embodiment of the present disclosure;

FIG. 9 is a schematic structural diagram of another flexible display module according to an embodiment of the present disclosure;

FIG. 10 is a schematic structural diagram of another flexible display module according to an embodiment of the present disclosure;

FIG. 11 is a schematic structural diagram of another flexible display module according to an embodiment of the present disclosure;

FIG. 12 is a schematic structural diagram of another flexible display module according to an embodiment of the present disclosure;

FIG. 13 is a cutting principle schematic diagram according to an embodiment of the present disclosure;

FIG. 14 is a flowchart of a method for manufacturing the flexible display module according to an embodiment of the present disclosure; and

FIG. 15 is a schematic structural diagram of a display device according to an embodiment of the present disclosure;

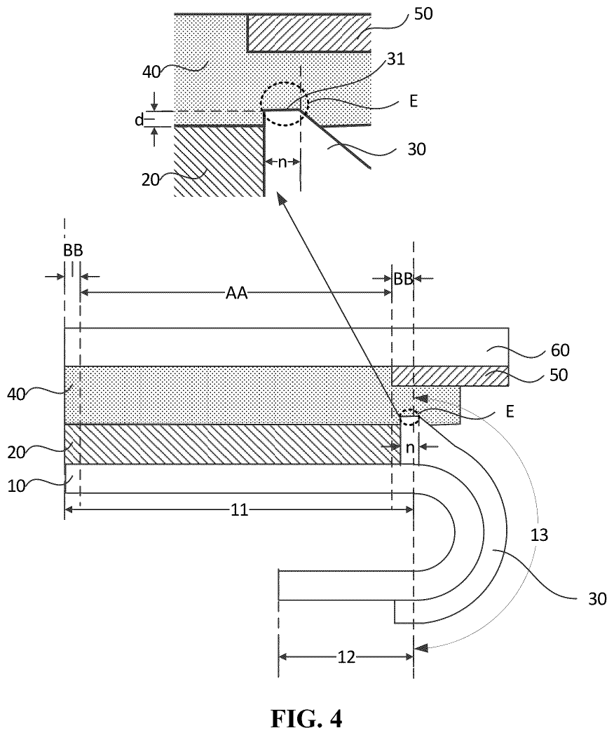

Herein, in FIGS. 4, 8, 9, 10, 11 and 12, a small picture is an enlarged picture of a first area and its surrounding area in a large picture.

### DETAILED DESCRIPTION

In order to more clearly understand the above-mentioned purpose, features and advantages of the present disclosure, the scheme of the present disclosure will be further described below. It should be noted that, in the absence of conflict, the embodiments of the present disclosure and the features in the embodiments can be combined with each other.

In the following description, many specific details are explained to facilitate a full understanding of the present disclosure, but the present disclosure can also be implemented in other ways different from those described herein; apparently, the embodiments in the specification are only part of the embodiments of the present disclosure, rather than all of embodiments.

As described in the background technology, in the pursuit of the ultimate visual effect and design aesthetics, how to further reduce the border width of the flexible display module, especially to achieve a narrower border design, is still a technical problem that needs to be solved urgently.

After a thorough study of the prior art, the applicant found that one of the reasons for the wide border of the current flexible display module is that the overlap amount between the light shielding layer and the polarizer is too large.

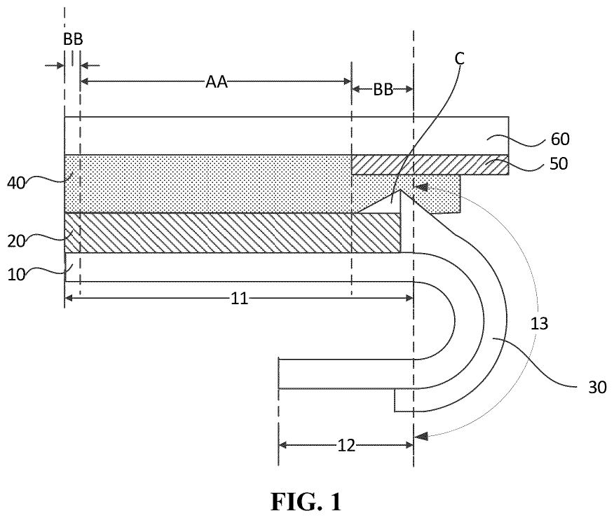

FIG. 1 is a schematic structural diagram of an existing flexible display module. Specifically, referring to FIG. 1, the flexible display module includes a flexible display panel 10, a polarizer 20, a bending protection layer 30, an adhesive layer 40, a light shielding layer 50, and a cover plate 60. The flexible display panel 10 includes a first non-bending portion 11, a second non-bending portion 12, and a bending portion 13 located between the first non-bending portion 11 and the second non-bending portion 12; the first non-bending portion 11 includes a display area AA and a non-display area BB surrounding the display area AA; the polarizer 20 is located on the light-emitting side of the first non-bending portion 11 and the covers the display area AA and part of the non-display area BB. The bending protection layer 30 and the polarizer 20 are located on the same side of the flexible display panel 10, and the bending protection layer 30 covers the bending portion 13 and is in contact with an edge of the polarizer 20. The adhesive layer 40 is located on one side of the polarizer 20 away from the flexible display panel 10 and covers the polarizer 20 and at least part of the bending protection layer 30. The function of the adhesive layer 40 is to bond the cover plate 60 to the polarizer 20 and the bending protection layer 30 by means of the adhesive force of the adhesive layer 40.

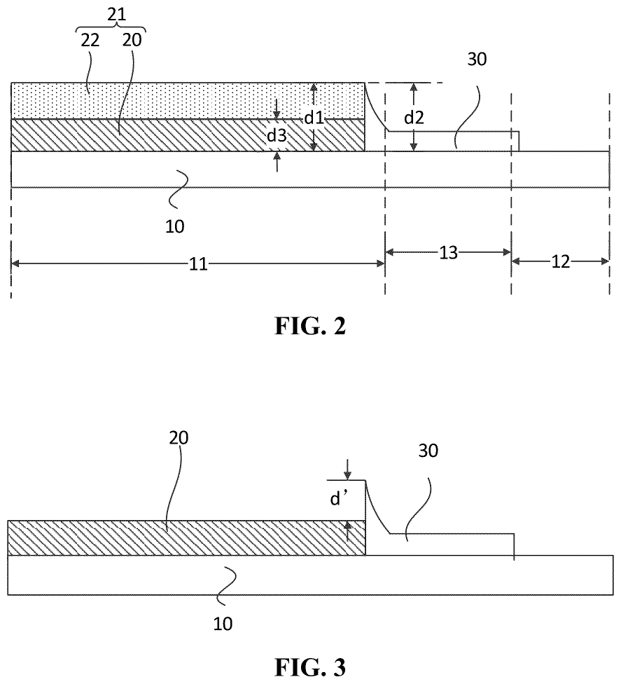

Still referring to FIG. 1, in the flexible display module, there is a bubble C in the adhesive layer 40. Specifically, the bubble C is formed by enclosing a side wall of the bending protection layer 30, a surface of the polarizer 20 away from the flexible display panel 10, and a surface of the adhesive layer 40 close to the flexible display panel 10. The reason for the formation of this bubble C is that in the manufacturing process of the flexible display module, the polarizer assembly 21 is first attached to the light-emitting side of the first non-bending portion 11 of the flexible display panel 10; the polarizer assembly 20 here includes a polarizer protection film 22 and a polarizer 20; and then a liquid colloid is coated on the bending area 13 of the flexible display panel 10, and the liquid colloid needs to be in contact with the side wall of the polarizer 20. Referring to FIG. 2, after the liquid colloid is in contact with the side wall of the polarizer 20, the liquid colloid may be subjected to tension and climb along the side wall of the polarizer 20 and the side wall of the polarizer protection film 22 until the liquid colloid is flush with the polarizer protection film 22. That is, at a contact position between the bending protection layer 30 and the side wall of the polarizer 20, if a distance from a surface of the polarizer protection film 22 away from the flexible display panel 10 to a surface of the flexible display panel 10 close to the polarizer protection film 22 is d1 and a distance from a surface of the polarizer 20 away from the flexible display panel 10 to a surface of the flexible display panel 10 close to the polarizer 20 is d3. Assuming that a distance from a surface of the bending protection layer 30 away from the flexible display panel 10 to a surface of the flexible display panel 10 close to the bending protection layer 30 is d2. Next, the liquid colloid is solidified, and the solidified colloid is the bending protection layer 30. Finally, the polarizer protection film 22 is removed. Comparing FIG. 2 and FIG. 3, after removing the polarizer protection film 22, the bending protection layer 30 forms a step difference in the contact area with the polarizer 20, and a height of the step difference is d′, d′=d2−d3. When the adhesive layer 40 is subsequently manufactured, the height d′ of the step difference is too large, which exceeds the step difference filling capacity of the adhesive layer 40, resulting in the formation of bubble C at the step difference.

In order to ensure the appearance of the display module, it is necessary to use a light shielding layer 50 to block the bubble C. Specifically, referring to FIG. 1, the light shielding layer 50 and the bubble C overlap in a direction perpendicular to the light-emitting surface of the flexible display panel 10.

This solution may cause the overlap amount (that is, the overlapping area of the light shielding layer 50 and the polarizer 20 in a direction perpendicular to the light-emitting surface of the flexible display panel 10) of the light shielding layer 50 and the polarizer 20 to be too large, resulting in the border of the flexible display module being too large, which is obviously contrary to the development trend of the narrow border of the flexible display module.

In view of this, the present application provides a flexible display module. FIG. 4 is a schematic structural cross-sectional view of a flexible display module according to an embodiment of the present disclosure. Referring to FIG. 4, the flexible display module includes: a flexible display panel 10, a polarizer 20, a bending protection layer 30, and an adhesive layer 40. The flexible display panel 10 includes a first non-bending portion 11, a second non-bending portion 12, and a bending portion 13 located between the first non-bending portion 11 and the second non-bending portion 12; the first non-bending portion 11 includes a display area AA and a non-display area BB surrounding the display area AA. The polarizer 20 is located on the light-emitting side of the first non-bending portion 11 and covers the display area AA and part of the non-display area BB. The bending protection layer 30 and the polarizer 20 are located on the same side of the flexible display panel 10, the bending protection layer 30 covers the bending portion 13 and is in contact with an edge of the polarizer 20. The adhesive layer 40 is located on one side of the polarizer 20 away from the flexible display panel 10 and covers the polarizer 20 and at least part of the bending protection layer 30. In the bending protection layer 30, an area in contact with the polarizer 20 is a first area E; in the first area E, a difference between a maximum thickness of the bending protection layer 30 and a thickness of the polarizer 20 is d, 0≤d≤m, and the value of m is proportional to the thickness of the adhesive layer 40.

Herein, m is a maximum step difference filling capacity of the adhesive layer. The maximum step difference filling capacity of the adhesive layer refers to a maximum size of the step difference (i.e., the maximum height difference) that can be handled under a condition that there is a height difference existed between the bonding surfaces (in this application, the height difference existed between the bonding surfaces refers to a height difference between the surface of the polarizer away from the flexible display panel and the surface of the bending protection layer away from the flexible display panel), these differences can be effectively filled and no obvious bubbles are generated inside the adhesive layer, or even if bubbles are formed, the bubbles can be controlled to a very small size. In practice, the maximum step difference filling capacity of the adhesive layer is related to the material and thickness of the adhesive layer.

Further, when the material of the adhesive layer is constant, the maximum step difference filling capacity of the adhesive layer is proportional to the thickness of the adhesive layer. That is, the value of m is proportional to the thickness of the adhesive layer.

In practice, the value of m is proportional to the thickness of the adhesive layer, for example, it can mean that the value of m increases with the increase of the thickness of the adhesive layer. Further, the value of m is linearly proportional or nonlinearly proportional to the thickness of the adhesive layer. In practice, the specific proportional relationship between the value of m and the thickness of the adhesive layer can be obtained through experiments. Exemplarily, multiple groups of corresponding relationships are obtained through experiments, and the corresponding relationships include the corresponding relationships between the thickness of the adhesive layer and the value of m. In different corresponding relationships, the thicknesses of the adhesive layer are different. Then, the thickness of the adhesive layer is used as a horizontal coordinate and the value of m is used as a vertical coordinate. The data points corresponding to each corresponding relationship are determined in the rectangular coordinate system, and then all the data points are linearly fitted to obtain a fitting line. In this way, based on the fitting line and the thickness of the adhesive layer to be manufactured, the value of m corresponding to the thickness of the adhesive layer to be manufactured can be obtained.

Exemplarily, if the material of the adhesive layer is an optical adhesive, it can be obtained through experiments that a maximum step difference filling capacity of the optical adhesive with a thickness of 100 um is 25 um, a maximum step difference filling capacity of the optical adhesive with a thickness of 125 um is 35 um, and a maximum step difference filling capacity of the optical adhesive with a thickness of 150 um is 45 um. Based on this, the coordinate values of the three data points are (100 um, 25 um), (125 um, 35 um) and (150 um, 45 um), respectively. In the rectangular coordinate system, the specific positions of the three data points are determined. The linear fitting is performed on the three data points to obtain a fitting line. In this way, based on the fitting line and the thickness of the adhesive layer to be manufactured, the value of m corresponding to the thickness of the adhesive layer to be manufactured can be obtained.

In one scenario, if the value of m is linearly proportional to the thickness p of the adhesive layer, the linear proportional relationship may be represented as:

$$m = k \cdot p + a$$

where k and a are both constants.

Optionally, during the manufacturing, the value of m is determined according to the thickness of the adhesive layer to be manufactured, and then based on the value of m, the value range of d is determined so that a difference d between a maximum thickness of a final bending protection layer and a thickness of the polarizer satisfies 0≤d≤m.

The above-mentioned technical solution is adopted in the bending protection layer, and an area in contact with the polarizer is a first area; in the first area, the difference between the maximum thickness of the bending protection layer and the thickness of the polarizer is d, 0≤d≤m, and the value of m is proportional to the thickness of the adhesive layer, which can make the height difference between the surface of the polarizer away from the flexible display panel and the surface of the bending protection layer away from the flexible display panel within the maximum step difference filling capacity of the adhesive layer. In this way, there are no bubbles in the adhesive layer close to the contact position between the polarizer and the bending protection layer, or although there are bubbles, the size of the bubbles is extremely small. In this way, the overlap amount (that is, the size of the overlapping area of the light shielding layer and the polarizer in a direction perpendicular to the light-emitting surface of the flexible display panel) of the light shielding layer and the polarizer can be reduced later, thereby reducing the border of the display module.

On the basis of the above-mentioned technical solutions, optionally, referring to FIG. 4, the flexible display module may further include a cover plate 60 and a light shielding layer 50; the cover plate 60 is located on one side of the adhesive layer 40 away from the polarizer 20 and covers the polarizer 20 and at least part of the bending protection layer 30; the light shielding layer 50 is located between the adhesive layer 40 and the cover plate 60 and covers at least part of the first area E. In this way, the flexible display panel can be protected with the help of the cover plate 60, thereby improving the service life of the flexible display module. The light shielding layer 50 can be provided to block the tiny bubbles that may exist in the adhesive layer 40 close to the first area E, and can also shield the edge light leakage at the edge of the polarizer 20 to improve the display effect of the flexible display module. Specifically, the edge of the polarizer 20 may shrink due to process or physical properties, resulting in the possibility of light leakage at the edge of the polarizer 20. These edge light leakages may affect the display effect of the flexible display module. By using the light shielding layer 50 to block the edge light leakage at the edge of the polarizer 20, the edge light leakage can be prevented from affecting the display effect of the flexible display module, thereby improving the display quality.

In the above-mentioned technical solution, optionally, there are multiple specific implementation methods to achieve the purpose of “in the first area, the difference d between the maximum thickness of the bending protection layer and the thickness of the polarizer satisfies 0≤d≤m”, which is not limited by this application. Exemplarily, the method for achieving the purpose of “in the first area, the difference d between the maximum thickness of the bending protection layer and the thickness of the polarizer satisfies 0≤d≤m” may include at least one of the following: modifying a surface of the side wall in contact with the bending protection layer in the polarizer and/or the polarizer protection film; coating an isolation layer on the side wall in contact with the bending protection layer in the polarizer and/or the polarizer protection film; and manufacturing and adding tiny barbs or textures to the side wall in contact with the bending protection layer in the polarizer and/or the polarizer protection film. These methods can inhibit the liquid colloid from climbing along the side wall of the polarizer and the polarizer protection film.

In one example, the method for achieving the purpose of “in the first area, the difference d between the maximum thickness of the bending protection layer and the thickness of the polarizer satisfies 0≤d≤m” may also include: cutting the bending protection layer in the first area E so that the difference d between the maximum thickness of the final bending protection layer and the thickness of the polarizer satisfies 0≤d≤m. Optionally, the bending protection layer in the first area E may be cut using a laser cutter so that the difference d between the maximum thickness of the final bending protection layer and the thickness of the polarizer satisfies 0≤d≤m. The advantage of this method is that it is easy to implement, and there is no interaction among chemicals, polarizer and flexible display panel, which does not affect the polarization effect of the polarizer and the display effect and service life of the flexible display panel.

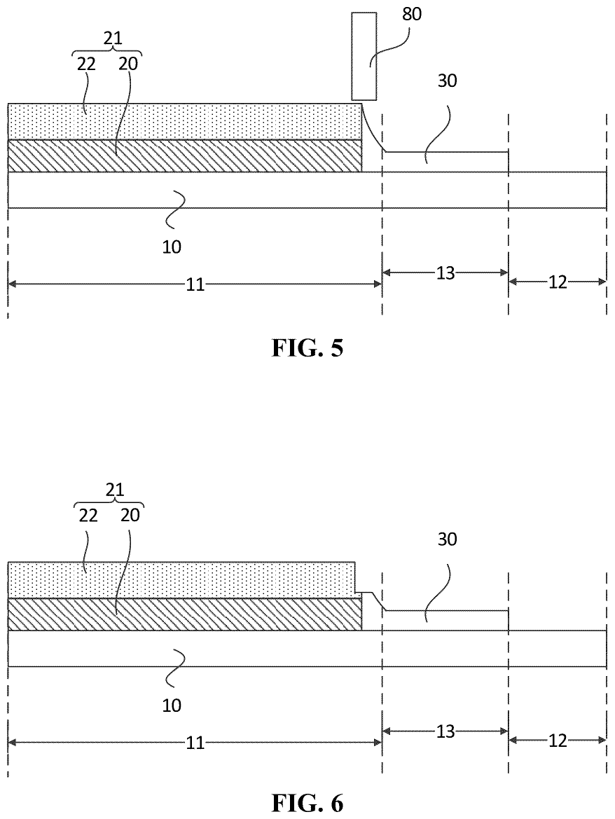

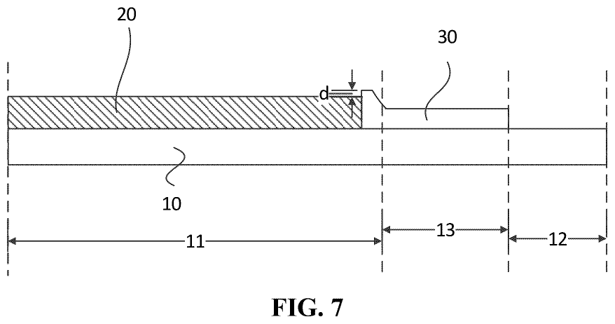

In one embodiment, the manufacturing method of the flexible display module may include: referring to FIG. 5, firstly attaching a polarizer assembly 21 to the light-emitting side of the first non-bending portion 11 of the flexible display panel 10; herein the polarizer assembly 21 includes a polarizer protection film 22 and a polarizer 20; and then coating a liquid colloid on the bending area 13 of the flexible display panel 10, herein the liquid colloid needs to be in contact with the polarizer assembly 21 (including the polarizer protection film 22 and the polarizer 20). After the liquid colloid contacts the side wall of the polarizer assembly 21 (including the polarizer protection film 22 and the polarizer 20), the liquid colloid may climb along the side wall of the polarizer assembly 21 (including the polarizer protective film 22 and the polarizer 20) under the action of tension until the liquid colloid is flush with the polarizer protection film 22. Then, the liquid colloid is cured, and the cured colloid is the bending protection layer 30. Then, the bending protection layer 30 in the first area E is cut by using a laser cutter 80. FIG. 6 is a display module obtained after cutting the bending protection layer. Finally, referring to FIG. 7, the polarizer protection film is removed. After removing the polarizer protection film 22, a step difference is formed in the contact area between the bending protection layer 30 and the polarizer 20, and the height d of the step difference satisfies 0≤d≤m.

Still referring to FIG. 6, during the manufacturing process of the flexible display module, when the bending protection layer 30 in the first area E is cut, although the cutting object is mainly the bending protection layer 30, due to the limitation of cutting accuracy, in the actual cutting process, the cutting range may affect the location where the polarizer 20 is arranged. As shown in FIG. 6, during the cutting of the bending protection layer 30, the polarizer protection film 22 is cut at the same time. For this case, 0<d≤m is optionally set. If d=0, it means that the maximum thickness of the bending protection layer 30 is the same as the thickness of the polarizer 20, which indicates that during the cutting process, the polarizer protection film 22 adjacent to the first area E may be completely removed. In practice, if the cutting accuracy is not well controlled, the polarizer 20 may be damaged.

Further, the material of the adhesive layer is an optical adhesive, and the thickness of the optical adhesive is greater than or equal to 100 um, 5 um≤d=25 um. This setting can further ensure that the step difference between the adhesive layer and the polarizer is less than the maximum step difference filling capacity of the adhesive layer, thereby ensuring that large bubbles are avoided, and the overlap amount (that is, the size of the overlapping area of the light shielding layer and the polarizer in the direction perpendicular to the light-emitting surface) of the light shielding layer and the polarizer can be reduced later, thereby reducing the border of the display module. In addition, it can also ensure that when the bending protection layer is cut, the polarizer protection film adjacent to the first area may not be cut.

On the basis of the above-mentioned technical solution, the difference d between the maximum thickness of the bending protection layer 30 and the thickness of the polarizer 20 is controlled, and the solution is realized by cutting the bending protection layer 30 in the first area E. Optionally, referring to FIG. 4, the first area E may be further set to be an area defined by a preset length n, starting from a junction of the polarizer 20 and the bending protection layer 30, extending in a direction from the polarizer 20 to the bending protection layer 30; 50 um≤n≤100 um. In practice, since it is necessary to cut the bending protection layer 30 in the first area E, in order to avoid damaging the polarizer 20 during the cutting process, 50 um≤n=100 um is set, the purpose is to determine the cutting center point of the cutter at a suitable position, avoid the cutting center point being too close to the polarizer 20, or directly located on the polarizer 20, so as to reduce the probability of the polarizer 20 being damaged during the cutting process.

On the basis of the above-mentioned technical solutions, optionally, in the first area, a surface of the bending protection layer away from the flexible display panel includes a plane and/or a cambered surface.

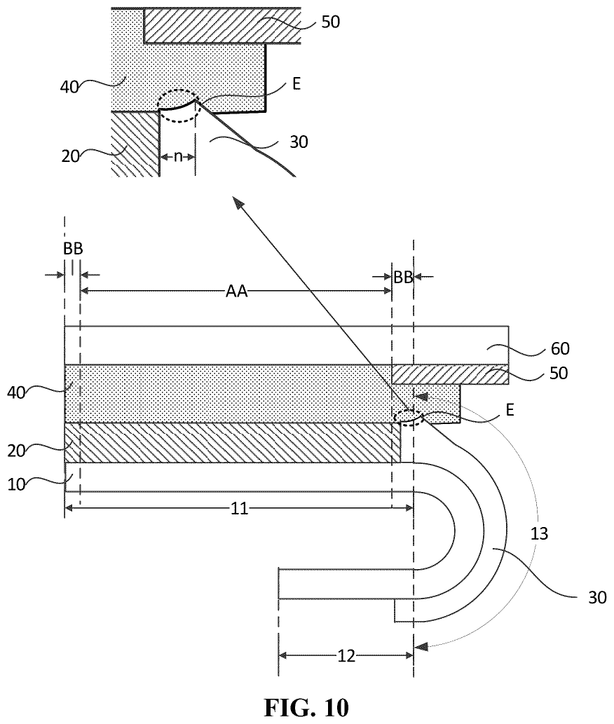

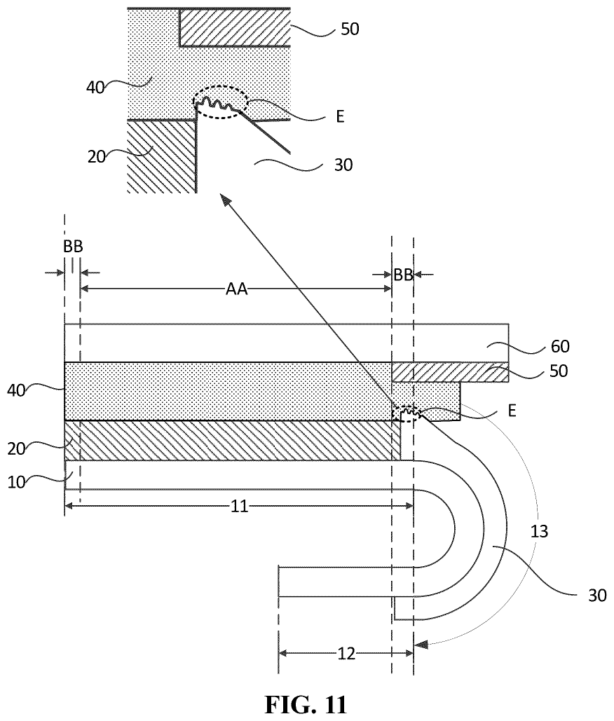

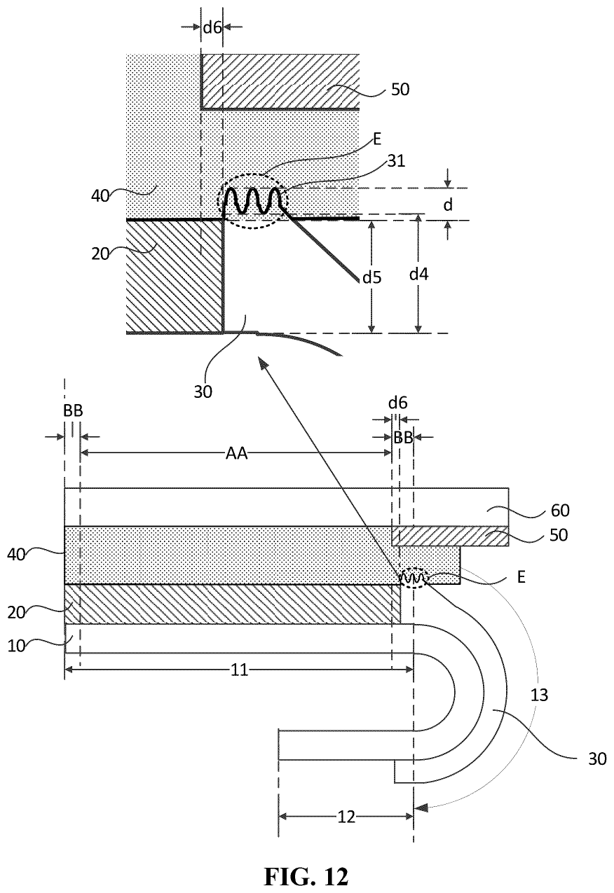

Exemplarily, in FIGS. 4, 8 and 9, in the first area E, a surface of the bending protection layer 30 away from the flexible display panel 10 is a plane. In FIG. 10, in the first area E, a surface of the bending protection layer 30 away from the flexible display panel 10 is a cambered surface. In FIG. 11, in the first area E, a surface of the bending protection layer 30 away from the flexible display panel 10 includes a plane and a cambered surface. In FIG. 12, in the first area E, a surface of the bending protection layer 30 away from the flexible display panel 10 includes a plurality of cambered surfaces with different sizes.

Further, in the first area, the surface of the bending protection layer away from the flexible display panel is the first surface, and the first surface is a plane; an included angle between a plane where the first surface is located and a plane where the first non-bending portion is located is α, 0°≤α≤45°, or 135°≤α<180°.

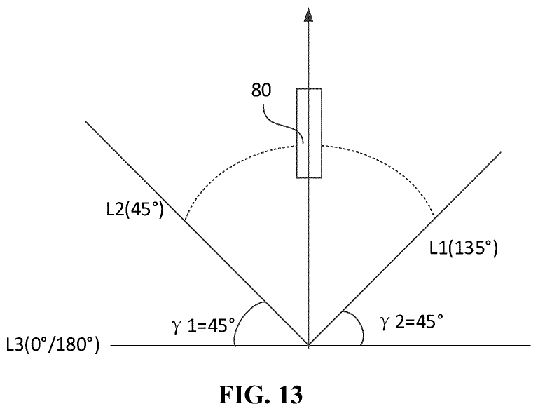

Exemplarily, referring to FIG. 13, L3 represents a plane parallel to the plane (it can also be understood as the plane where the light-emitting surface in the first non-bending portion is located) where the first non-bending portion is located. If the plane where the first surface is located is parallel to L3, the corresponding structure is shown in FIG. 4, and the included angle between the plane where the first surface 31 is located and the plane where the first non-bending portion 11 is located is 0° or 180°.

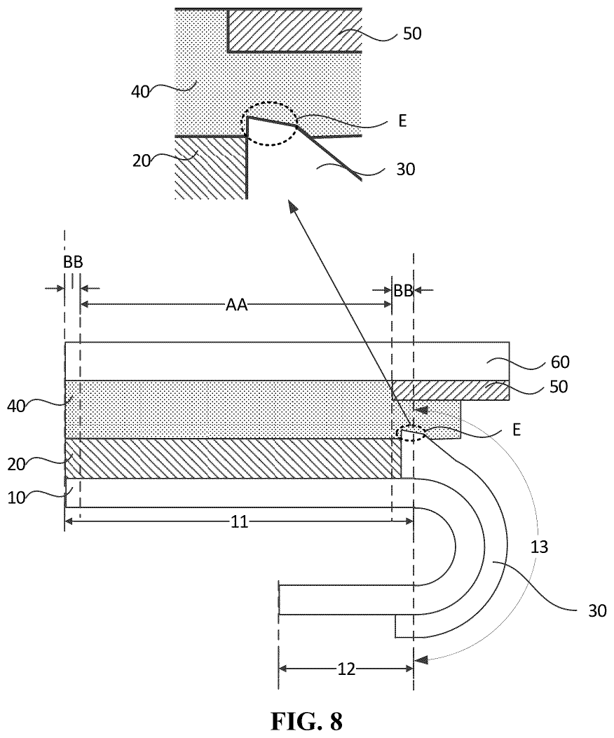

If the plane where the first surface is located is parallel to L2, at this time, the included angle between the plane where the first surface is located and the plane where the first non-bending portion is located is 45°. The included angle α between the plane where the first surface is located and the plane where the first non-bending portion is located satisfies 0°≤α≤45°, which indicates that the included angle between the plane where the first surface is located and L3 is within the range of γ1, and the corresponding structure is shown in FIG. 8.

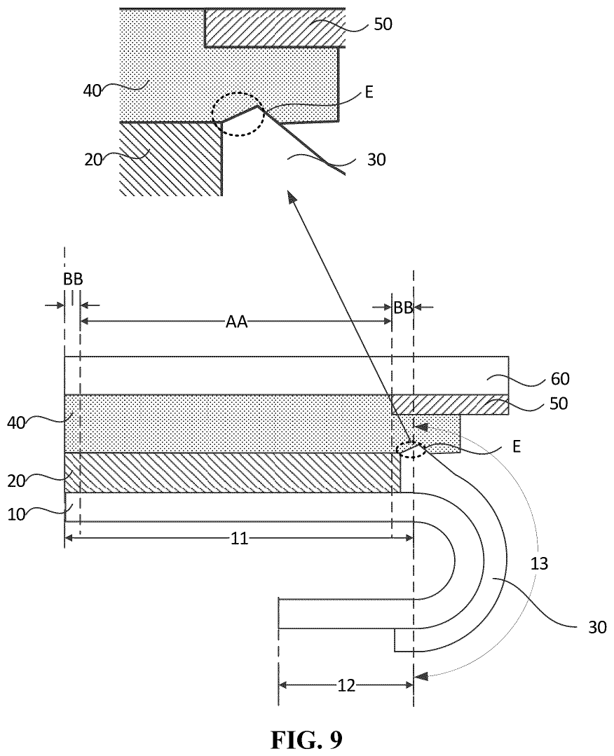

If the plane where the first surface is located is parallel to L1, at this time, the included angle between the plane where the first surface is located and the plane where the first non-bending portion is located is 135°. The included angle α between the plane where the first surface is located and the plane where the first non-bending portion is located satisfies 135°≤α<180°, which indicates that the included angle between the plane where the first surface is located and L3 is within the range of γ2, and the corresponding structure is shown in FIG. 9.

In the scenario where the bending protection layer is cut by using a laser, the included angle between the plane where the first surface is located and the plane where the first non-bending portion is located is set to α, 0°≤α≤45°, or 135°≤α<180°, its essence is to limit a placement angle of the laser relative to the flexible display module during the cutting process. The specific placement angle of the laser is shown by the dotted line in FIG. 13, and its included angle with the direction (the direction of the arrow in FIG. 13) perpendicular to the light-emitting surface of the flexible display panel is β, −45°≤β≤45°. This setting can avoid the undesirable phenomenon that the bending protection layer cannot be effectively cut or the polarizer or other film layers are damaged due to the inappropriate placement angle of the laser relative to the flexible display module.

Furthermore, it can be arranged that in the first area, a surface of the bending protection layer away from the flexible display panel is in an uneven shape. The reason for this arrangement is that the bending protection layer and the cover plate need to be bonded together with the help of the adhesive layer later. By arranged the surface of the bending protection layer away from the flexible display panel to be in an uneven shape, the bonding strength between the cover plate and the bending protection layer can be improved.

Based on the above-mentioned technical solution, optionally, referring to FIG. 12, the surface of the bending protection layer 30 away from the flexible display panel 10 is the first surface 31; in the first area E, along the direction perpendicular to the flexible display panel 10, a distance d4 from a lowest point of the first surface 31 to the flexible display panel 10 is greater than a thickness d5 of the polarizer 20. Herein, the distance from the lowest point of the first surface to the flexible display panel 10 may, for example, refer to a minimum distance from the first surface 31 to the surface of the flexible display panel 10 close to the bending protection layer 30 in the first area E.

For the case where the difference d between the maximum thickness of the bending protection layer 30 and the thickness of the polarizer 20 satisfies 0≤d≤m in the first area E by using the method of cutting the bending protection layer 30, the distance from the lowest point of the first surface 31 to the flexible display panel 10 is set to be greater than the thickness of the polarizer 20 in the direction perpendicular to the flexible display panel 10, which can avoid the undesirable situation of causing damage to the polarizer 20 in the process of manufacturing the first surface 31.

Further, referring to FIGS. 11 and 12, the first surface may be arranged to include a concave portion and a convex portion, the concave portion and the convex portion being alternately arranged along any direction parallel to a plane where the flexible display panel is located. The purpose of this arrangement is to further improve the bonding strength between the cover plate 60 and the bending protection layer 30.

On the basis of the above-mentioned technical solution, further, referring to FIG. 12, along the direction from the polarizer 20 to the bending protection layer 30, with an edge of the light shielding layer 50 close to the display area AA as a starting point, and a contact position between the bending protection layer 30 and the polarizer 20 as an end point, a distance d6 from the starting point to the end point is greater than or equal to 100 μm, and less than or equal to 350 μm. The purpose of this setting is to use the light shielding layer 50 to block the edge light leakage of the edge of the polarizer 20, improve the display effect of the flexible display module, and improve the aesthetics of the flexible display module. It should be noted that in the present application, the minimum value of d6 may be 100 μm. This is precisely due to the adoption of the technical solution provided by the present application, and the technical solution provided by the present application can reduce or eliminate bubbles as much as possible, which is based on this fact. In other words, if the technical solution provided by the present application is not adopted, the value of d6 needs to be much greater than 100 μm.

Based on the same inventive concept, the present application also provides a flexible display module, as shown in FIG. 4, which includes: a flexible display panel 10, a polarizer 20, a bending protection layer 30, and an adhesive layer 40. The flexible display panel 10 includes a first non-bending portion 11, a second non-bending portion 12, and a bending portion 13 located between the first non-bending portion 11 and the second non-bending portion 12; the first non-bending portion 11 includes a display area AA and a non-display area BB surrounding the display area AA. The polarizer 20 is located on the light-emitting side of the first non-bending portion 11 and covers the display area AA and part of the non-display area BB. The bending protection layer 30 and the polarizer 20 are located on the same side of the flexible display panel 10, the bending protection layer 30 covers the bending portion 13, and is in contact with the edge of the polarizer 20. The adhesive layer 40 is located on one side of the polarizer 20 away from the flexible display panel 10 and covers the polarizer 20 and at least part of the bending protection layer 30. In the bending protection layer 30, the area in contact with the polarizer 20 is the first area E; in the first area E, the surface of the bending protection layer 30 away from the flexible display panel 10 is a plane or a cambered surface.

Those skilled in the art can understand that in practice, under normal circumstances (such as not modifying the surface of the side wall in contact with the bending protection layer in the polarizer and/or the polarizer protection film; not coating an isolation layer on the side wall in contact with the bending protection layer in the polarizer and/or the polarizer protection film; and not manufacturing and adding tiny barbs or textures to the side wall in contact with the bending protection layer in the polarizer and/or the polarizer protection film), a liquid colloid is coated on the bending area of the flexible display panel, and the liquid colloid climbs along the side wall of the polarizer and the polarizer protection film until the liquid colloid is flush with the polarizer protection film. In this case, the final bending protection layer presents a “peak”-shaped sharp corner in the first area, rather than a plane or a cambered surface. In other words, the definition of “in the first area, the surface of the bending protection layer away from the flexible display panel is a plane or a cambered surface” means that the bending protection layer in the first area is cut, which means that at this time, the height of the step difference formed in the contact area between the bending protection layer 30 and the polarizer 20 is reduced, thereby achieving the purpose of reducing the size of the bubbles formed at the step difference, or even eliminating the bubbles.

Therefore, the above-mentioned technical solution is set in the bending protection layer 30, and the area in contact with the polarizer 20 is the first area E; in the first area E, the surface of the bending protection layer 30 away from the flexible display panel 10 is a plane or a cambered surface, so that there is a small height difference between the surface of the polarizer away from the flexible display panel and the surface of the bending protection layer away from the flexible display panel, and there are no bubbles in the adhesive layer close to the contact position between the polarizer and the bending protection layer, or although there are bubbles, the size of the bubbles is extremely small. In this way, the overlap amount (that is, the size of the overlapping area between the light shielding layer and the polarizer in the direction perpendicular to the light-emitting surface of the flexible display panel) of the light shielding layer and the polarizer can be reduced later, thereby reducing the border of the display module.

On the basis of the above-mentioned technical solution, optionally, in the first area, the thickness of the bending protection layer is greater than the thickness of the polarizer. The purpose of this setting is to avoid damaging the polarizer when cutting the bending protection layer.

Further, the first area is an area defined by a preset length n, starting from the junction of the polarizer and the bending protection layer, extending in the direction from the polarizer to the bending protection layer, where 50 um≤n≤100 um. In practice, since it is necessary to cut the bending protection layer 30 in the first area E, in order to avoid damaging the polarizer 20 during the cutting process, by setting 50 um≤n≤100 um, the purpose is to determine the cutting center point of the cutter at a suitable position, avoid the cutting center point being too close to the polarizer 20, or directly located on the polarizer 20, so as to reduce the probability of the polarizer 20 being damaged during the cutting process.

Further, in the first area, the surface of the bending protection layer away from the flexible display panel includes a plane and/or a cambered surface.

Further, it can be arranged that, in the first area, the surface of the bending protection layer away from the flexible display panel is the first surface, and the first surface is a plane;
an included angle between the plane where the first surface is located and the plane where the first non-bending portion is located is α, where 0°≤α≤45°, or 135°≤α<180°.

Further, in the first area, the surface of the bending protection layer away from the flexible display panel is in an uneven shape.

Further, the surface of the bending protection layer away from the flexible display panel is the first surface;

In the first area, along the direction perpendicular to the flexible display panel, the distance from the lowest point of the first surface to the flexible display panel is greater than the thickness of the polarizer.

Further, the first surface includes a concave portion and a convex portion, and the concave portion and the convex portion being alternately arranged along any direction parallel to the plane where the flexible display panel is located.

Further, the flexible display module further includes a cover plate and a light shielding layer;

The cover plate is located on one side of the adhesive layer away from the polarizer and covers the polarizer and at least part of the bending protection layer;

The light shielding layer is located between the adhesive layer and the cover plate and covers at least part of the first area.

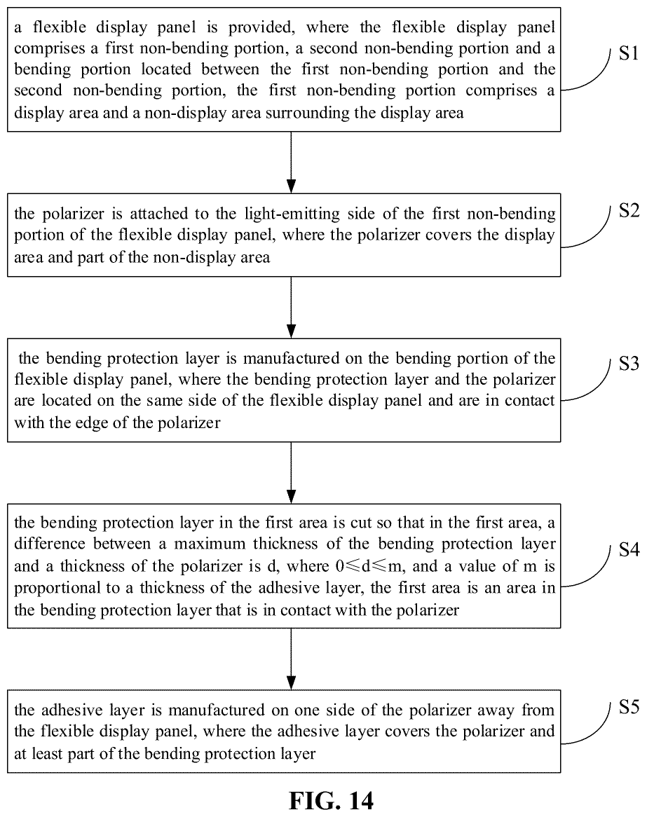

Based on the same inventive concept, the present application also provides a method for manufacturing a flexible display module. FIG. 14 is a flowchart of a method for manufacturing a flexible display module according to an embodiment of the present disclosure. The method for manufacturing the flexible display module is used to manufacture any one of the above-mentioned flexible display modules. Referring to FIG. 14, the method for manufacturing the flexible display module may include S1˜S5.

In S1, a flexible display panel is provided, where the flexible display panel comprises a first non-bending portion, a second non-bending portion and a bending portion located between the first non-bending portion and the second non-bending portion, the first non-bending portion comprises a display area and a non-display area surrounding the display area.

In S2, the polarizer is attached to the light-emitting side of the first non-bending portion of the flexible display panel, where the polarizer covers the display area and part of the non-display area.

In S3, the bending protection layer is manufactured on the bending portion of the flexible display panel, where the bending protection layer and the polarizer are located on the same side of the flexible display panel and are in contact with the edge of the polarizer;

In S4, the bending protection layer in the first area is cut so that in the first area, a difference between a maximum thickness of the bending protection layer and a thickness of the polarizer is d, where 0≤d≤m, and a value of m is proportional to a thickness of the adhesive layer, the first area is an area in the bending protection layer that is in contact with the polarizer.

In S5, the adhesive layer is manufactured on one side of the polarizer away from the flexible display panel, where the adhesive layer covers the polarizer and at least part of the bending protection layer.

The above-mentioned method for manufacturing the flexible display module is used to manufacture any one of the flexible display modules provided in the present application, the method has the same or corresponding beneficial effects of the flexible display module, which will not be repeated here.

Further, S2 includes: attaching a polarizer assembly on the light-emitting side of the first non-bending portion of the flexible display panel, the polarizer assembly including a polarizer and a polarizer protection film; after attaching the polarizer assembly, the polarizer is located between the flexible display panel and the polarizer protection film; and S4 includes: cutting the bending protection layer and the polarizer protection film in the first area; after cutting, removing all polarizer protection films on the polarizer.

Further, S4 includes: using a laser cutter to cut the bending protection layer and the polarizer protection film in the first area; during the cutting process, an included angle between a central axis of a laser beam of the laser cutter and a direction perpendicular to the first non-bending portion is controlled to be β, −45°≤β≤45°.

Further, after S5, the method also includes:
manufacturing a light shielding layer on one side of the adhesive layer away from the polarizer, the light shielding layer covering at least a part of the first area; and
manufacturing a cover plate on one side of the light shielding layer away from the adhesive layer, the cover plate covering the polarizer and at least part of the bending protection layer.

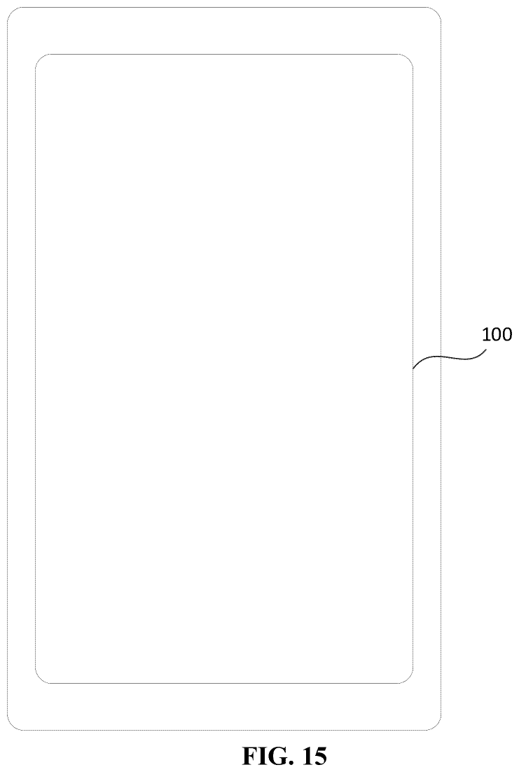

Based on the same inventive concept, the present application also provides a display device. FIG. 15 is a schematic structural diagram of a display device according to an embodiment of the present disclosure. Referring to FIG. 15, the display device includes any one of the flexible display modules 100 provided in the embodiment of the present disclosure.

Since the display device provided in the present application includes any one of the flexible display modules provided in the present application, the display device has the same or corresponding beneficial effects as the flexible display module included therein, which will not be repeated here.

It should be noted that, in the present application, relational terms such as “first” and “second” are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “including one . . . ” do not exclude the existence of other identical elements in the process, method, article or device including the elements.

The above descriptions are only specific embodiments of the present disclosure, so that those skilled in the art can understand or implement the present disclosure. Various modifications to these embodiments will be obvious to those skilled in the art, and the general principles defined herein can be implemented in other embodiments without departing from the gist or scope of the present disclosure. Therefore, the present disclosure will not be limited to the embodiments described herein, but will conform to the widest scope consistent with the principles and novel features disclosed herein.

What is claimed is:

1. A flexible display module, comprising: a flexible display panel, a polarizer, a bending protection layer and an adhesive layer,
wherein the flexible display panel comprises a first non-bending portion, a second non-bending portion and a bending portion located between the first non-bending portion and the second non-bending portion; the first non-bending portion comprises a display area and a non-display area surrounding the display area;
the polarizer is located on a light-emitting side of the first non-bending portion, and covers the display area and part of the non-display area;
the bending protection layer and the polarizer are located on a same side of the flexible display panel, the bending protection layer covers the bending portion and is in contact with an edge of the polarizer;
the adhesive layer is located on one side of the polarizer away from the flexible display panel, and covers the polarizer and at least part of the bending protection layer;
in the bending protection layer, an area in contact with the polarizer is a first area; in the first area, a difference between a maximum thickness of the bending protection layer and a thickness of the polarizer is d, where 0≤d≤m, and a value of m is proportional to a thickness of the adhesive layer.

2. The flexible display module according to claim 1, wherein a material of the adhesive layer is an optical adhesive, and a thickness of the optical adhesive is greater than or equal to 100 um;
where 5 um≤d≤25 um.

3. The flexible display module according to claim 1, wherein the first area is an area defined by a preset length n, starting from a junction of the polarizer and the bending protection layer, extending in a direction from the polarizer to the bending protection layer;
where 50 um≤n≤100 um.

4. The flexible display module according to claim 1, wherein in the first area, a surface of the bending protection layer away from the flexible display panel comprises a plane and/or a cambered surface.

5. The flexible display module according to claim 4, wherein in the first area, the surface of the bending protection layer away from the flexible display panel is a first surface, and the first surface being the plane;
an included angle between a plane where the first surface is located and a plane where the first non-bending portion is located is α, where 0°≤α≤45°, or 135°≤α<180°.

6. The flexible display module according to claim 4, wherein in the first area, the surface of the bending protection layer away from the flexible display panel is in an uneven shape.

7. The flexible display module according to claim 6, wherein the surface of the bending protection layer away from the flexible display panel is a first surface;
in the first area, along a direction perpendicular to the flexible display panel, a distance from a lowest point of the first surface to the flexible display panel is greater than a thickness of the polarizer.

8. The flexible display module according to claim 7, wherein the first surface comprises a concave portion and a convex portion, the concave portion and the convex portion being alternately arranged along any direction parallel to a plane where the flexible display panel is located.

9. The flexible display module according to claim 1, wherein the flexible display module further comprises a cover plate and a light shielding layer;
the cover plate being located on one side of the adhesive layer away from the polarizer, and covering the polarizer and at least part of the bending protection layer; and
the light shielding layer being located between the adhesive layer and the cover plate, and covering at least part of the first area.

10. The flexible display module according to claim 9, wherein along a direction from the polarizer to the bending protection layer, with an edge of the light shielding layer close to the display area as a starting point and a contact position between the bending protection layer and the polarizer as an end point, a distance from the starting point to the end point is greater than or equal to 100 μm and less than or equal to 350 μm.

11. A flexible display module, comprising: a flexible display panel, a polarizer, a bending protection layer and an adhesive layer,
wherein the flexible display panel comprises a first non-bending portion, a second non-bending portion and a bending portion located between the first non-bending portion and the second non-bending portion; the first non-bending portion comprises a display area and a non-display area surrounding the display area;
the polarizer is located on a light-emitting side of the first non-bending portion, and covers the display area and part of the non-display area;
the bending protection layer and the polarizer are located on a same side of the flexible display panel, the bending protection layer covers the bending portion and is in contact with an edge of the polarizer;
the adhesive layer is located on one side of the polarizer away from the flexible display panel, and covers the polarizer and at least part of the bending protection layer;
in the bending protection layer, an area in contact with the polarizer is a first area; in the first area, a surface of the bending protection layer away from the flexible display panel is a plane or a cambered surface.

12. The flexible display module according to claim 11, wherein a thickness of the bending protection layer in the first area is greater than a thickness of the polarizer.

13. The flexible display module according to claim 11, wherein the first area is an area defined by a preset length n, starting from a junction of the polarizer and the bending protection layer, extending in a direction from the polarizer to the bending protection layer;
where 50 um≤n≤100 um.

14. A method for manufacturing a flexible display module, which is used to manufacture the flexible display module comprising: a flexible display panel, a polarizer, a bending protection layer and an adhesive layer,
wherein the flexible display panel comprises a first non-bending portion, a second non-bending portion and a bending portion located between the first non-bending portion and the second non-bending portion; the first non-bending portion comprises a display area and a non-display area surrounding the display area;
the polarizer is located on a light-emitting side of the first non-bending portion, and covers the display area and part of the non-display area;
the bending protection layer and the polarizer are located on a same side of the flexible display panel, the bending protection layer covers the bending portion and is in contact with an edge of the polarizer;
the adhesive layer is located on one side of the polarizer away from the flexible display panel, and covers the polarizer and at least part of the bending protection layer;
in the bending protection layer, an area in contact with the polarizer is a first area; in the first area, a difference between a maximum thickness of the bending protection layer and a thickness of the polarizer is d, where 0≤d≤m, and a value of m is proportional to a thickness of the adhesive layer;
wherein the method comprising:
providing the flexible display panel that comprises the first non-bending portion, the second non-bending portion and the bending portion located between the first non-bending portion and the second non-bending portion, wherein the first non-bending portion comprises the display area and the non-display area surrounding the display area;
attaching the polarizer to the light-emitting side of the first non-bending portion of the flexible display panel, wherein the polarizer covers the display area and part of the non-display area;
manufacturing the bending protection layer on the bending portion of the flexible display panel, wherein the bending protection layer and the polarizer are located on the same side of the flexible display panel and are in contact with the edge of the polarizer;
cutting the bending protection layer in the first area so that in the first area, the difference between the maximum thickness of the bending protection layer and the thickness of the polarizer is d, where 0≤d≤m, and the value of m is proportional to the thickness of the adhesive layer, the first area is the area in the bending protection layer that is in contact with the polarizer; and
manufacturing the adhesive layer on one side of the polarizer away from the flexible display panel, wherein the adhesive layer covers the polarizer and at least part of the bending protection layer.

15. The method according to claim 14, wherein the attaching the polarizer to the light-emitting side of the first non-bending portion of the flexible display panel comprises:
attaching a polarizer assembly on the light-emitting side of the first non-bending portion of the flexible display panel, wherein the polarizer assembly comprises the polarizer and a polarizer protection film; after attaching the polarizer assembly, the polarizer is located between the flexible display panel and the polarizer protection film; and
the cutting the bending protection layer in the first area comprises:
cutting the bending protection layer and the polarizer protection film in the first area; and
removing all the polarizer protection films on the polarizer after cutting.

16. The method according to claim 15, wherein the cutting the bending protection layer and the polarizer protection film in the first area comprises:
using a laser cutter to cut the bending protection layer and the polarizer protection film in the first area; and during a cutting process, controlling an included angle between a central axis of a laser beam of the laser cutter and a direction perpendicular to the first non-bending portion to be β, where −45°≤β≤45°.

17. The method according to claim 14, wherein after the manufacturing the adhesive layer on one side of the polarizer away from the flexible display panel, the method further comprises:
manufacturing a light shielding layer on one side of the adhesive layer away from the polarizer, wherein the light shielding layer covers at least a part of the first area; and
manufacturing a cover plate on one side of the light shielding layer away from the adhesive layer, wherein the cover plate covers the polarizer and at least part of the bending protection layer.

18. A method for manufacturing a flexible display module, which is used to manufacture the flexible display module according to claim 11, wherein the method comprising:
providing the flexible display panel that comprises the first non-bending portion, the second non-bending portion and the bending portion located between the first non-bending portion and the second non-bending portion, wherein the first non-bending portion comprises the display area and the non-display area surrounding the display area;
attaching the polarizer to the light-emitting side of the first non-bending portion of the flexible display panel, wherein the polarizer covers the display area and part of the non-display area;
manufacturing the bending protection layer on the bending portion of the flexible display panel, wherein the bending protection layer and the polarizer are located on the same side of the flexible display panel and are in contact with the edge of the polarizer;
cutting the bending protection layer in the first area so that in the first area, the difference between the maximum thickness of the bending protection layer and the thickness of the polarizer is d, where 0≤d≤m, and the value of m is proportional to the thickness of the adhesive layer, the first area is the area in the bending protection layer that is in contact with the polarizer; and
manufacturing the adhesive layer on one side of the polarizer away from the flexible display panel, wherein the adhesive layer covers the polarizer and at least part of the bending protection layer.

19. A display device, comprising the flexible display module according to claim 1.

20. A display device, comprising the flexible display module according to claim 11.
